(19) United States
(12) Patent Application Publication
(10) Pub. No.: US 2026/0307565 A1
(43) Pub. Date: Oct. 8, 2026

(54) MOLDED FOAM AND VEHICLE SEAT

(71) Applicant: TACHI-S CO., LTD., Tokyo (JP)

(72) Inventor: Takamasa TAMAI, Tokyo (JP)

(73) Assignee: TACHI-S CO., LTD., Tokyo (JP)

(21) Appl. No.: 19/573,180

(22) Filed: Mar. 20, 2026

(30) Foreign Application Priority Data
Apr. 4, 2025 (JP) 2025-062611

(51) Int. Cl. B60N 2/70

(52) U.S. Cl. CPC B60N 2/7035

(57) ABSTRACT

To provide a molded foam and a vehicle seat capable of improving degrees of freedom in the design of seat pads.

There are provided a main structure portion that extends in longer and shorter directions and configures a seating face or a backrest; side support portions that are placed on both ends of the main structure portion in a first direction, are molded integrally with the main structure portion, and protrude in a second direction; and insert materials that are provided in the side support portions and are harder than the side support portions. The insert materials include pin holes that can engage with a positioning pin for positioning to the insert material during foam molding. The pin holes include opened portions opened at one end in the first direction.

### CROSS-REFERENCE TO RELATED APPLICATION

The present application claims priority to Japanese patent application JP 2025-062611, filed Apr. 4, 2025, t he entire contents of which are being incorporated herein by reference.

### BACKGROUND OF THE INVENTION

The present invention relates to molded foam and a vehicle seat.

Generally, a seat back pad and a seat cushion pad (hereinafter simply referred to as a seat pad) of a vehicle seat are made of molded foam. Such a seat pad includes side support portions whose both ends of the seat surface protrude toward a seated person. Seat pads made of molded foam are based on the known insert molding technology that improves the support efficiency for seated persons by using a side support portion embedded with an insert material that is harder than the other parts.

The foam molding process for seat pads uses a mold composed of a cavity and a core, both of which open and close vertically. The insert material is positioned at the core. Then, an undiluted solution of the soft foam material is injected into the cavity to foam and harden. This results in the insert molding of the seat pad embedded with the insert material inside.

To further improve the support efficiency of a vehicle seat, the insert material must be precisely positioned and molded at a predetermined position inside the side support portion. In the vehicle seat described in Japanese Unexamined Patent Application Publication No. 2024-139056, a positioning pin for positioning the insert material is also protrusively provided vertically to correspond to the mold for foam molding. Accordingly, a positioning hole for the insert material, engaging with the positioning pin, is also formed vertically.

### SUMMARY OF THE INVENTION

Vehicle seats are required to enlarge the seating face to maintain the support efficiency and improve seating comfort for seated persons. However, the vehicle seat described in Patent Application Publication No. 2024-139056 needs to be thickened in the horizontal direction orthogonal to the vertical direction because the insert material includes the vertical positioning hole. In other words, it is difficult to thinly mold the insert material in the horizontal direction. Consequently, the insert material is thickened horizontally. An attempt to maintain the horizontal dimension of the vehicle seat fails to enlarge the seat surface. Improvement of the seat pad (molded foam) design is viewed as an issue.

The main object of the present invention is to provide a molded foam and a vehicle seat capable of improving degrees of freedom in the design of seat pads.

To achieve the above-described objective, a molded foam according to the present invention configures a seat pad for a vehicle seat and includes; a main structure portion that extends in a longer direction and a shorter direction and configures a seating face or a backrest; a side support portion that is placed at both ends of the main structure portion in a first direction as the shorter direction, is molded integrally with the main structure portion, and protrudes in a second direction intersecting the first direction; and an insert material provided that is provided inside the side support portion and is harder than the side support portion. The insert material includes a pin hole capable of engaging with a positioning pin that is used for positioning to the side support portion during foam molding and extends in the second direction. The pin hole includes an opened portion opened at one end in the first direction to release a mold for molding the insert material in the first direction.

According to the above-described configuration, the pin hole includes a semicircular portion whose inner diameter conforms to an outer diameter of the positioning pin, and a straight portion that communicates with the semicircular portion and the opened portion and is dimensioned, in a third direction intersecting the first and second directions, to conform to the outer diameter of the positioning pin.

According to the above-described configuration, the insert material includes a protruded portion formed to be placed inside the pin hole and protrude in the third direction. When the positioning pin engages with the pin hole, the protruded portion prevents the positioning pin from disengaging in the first direction.

To achieve the above-described objective, a vehicle seat according to the present invention includes the molded foam according to the above-described configuration and a frame that supports the molded foam. The frame includes a frame member that extends in a third direction intersecting the first and second directions. The insert material includes an insert material main structure portion supported by the frame member, and a first leg portion and a second leg portion, which are placed on both sides of the frame member in the first direction and are integrally formed with the insert material main structure portion. The first leg portion and the second leg portion position the molded foam to the frame member in the first direction.

The present invention can provide a molded foam and a vehicle seat capable of improving degrees of freedom in the design of seat pads. Problems, configurations, and effects, for example, other than those described above will become clear from the description of the following embodiment.

### BRIEF DESCRIPTION OF THE DRAWINGS

FIG. 1 is a perspective view of a vehicle seat according to an embodiment of the present invention;

FIG. 2 is a front view of the vehicle seat illustrated in FIG. 1;

FIG. 3 is a cross-sectional view taken along the line III-III of FIG. 2;

FIG. 4 is an exploded perspective view of a seat cushion;

FIG. 5 is a bottom perspective view of a seat cushion pad or a seat pad (molded foam);

FIG. 6A is a front perspective view of an insert material;

FIG. 6B is a rear perspective view of an insert material;

FIG. 7 is a right side view of the insert material;

FIG. 8 is a front view of the insert material;

FIG. 9 is a cross-sectional view taken along the line IX-IX of FIG. 7;

FIG. 10 is a cross-sectional view taken along the line X-X of FIG. 7;

FIG. 11A is an explanatory diagram illustrating a manufacturing process of the insert material (when the mold is closed);

FIG. 11B is an explanatory diagram illustrating a manufacturing process of the insert material (when the mold is opened);

FIG. 12A is an explanatory diagram illustrating a manufacturing process of the seat cushion pad (or the seat pad) (molded foam) (when the mold is opened); and

FIG. 12B is an explanatory diagram illustrating a manufacturing process of the seat cushion pad (or the seat pad) (molded foam) (when the mold is closed).

### DETAILED DESCRIPTION OF THE PREFERRED EMBODIMENTS

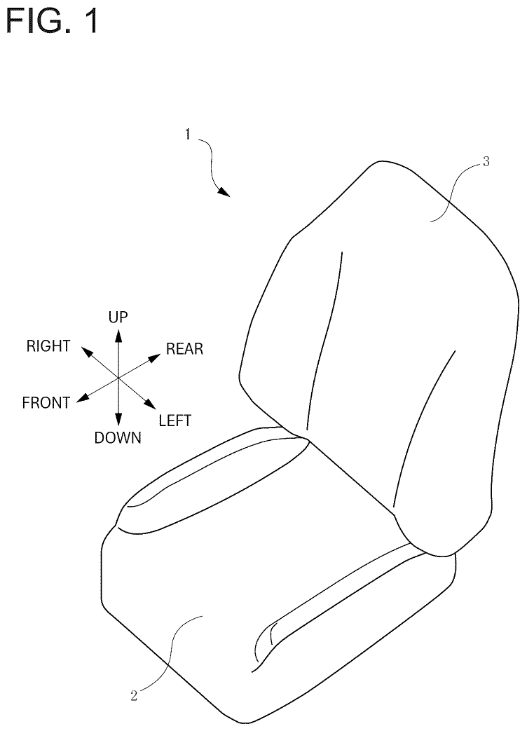

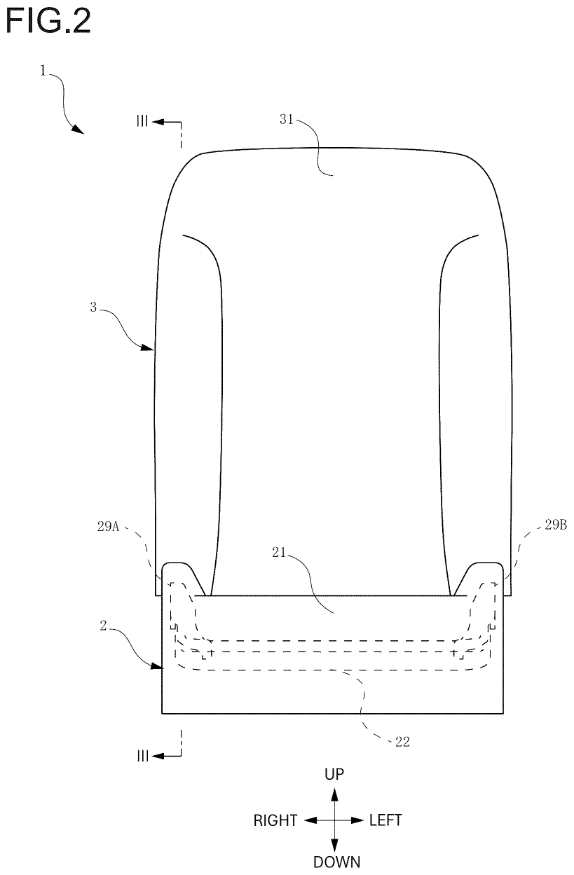

The following describes the vehicle seat according to the present invention by referencing the drawings. FIG. 1 is a perspective view of a vehicle seat 1 according to a present embodiment of the present invention. FIG. 2 is a front view of the vehicle seat 1 illustrated in FIG. 1. In the following description, the left-right arrow, the up-down arrow, and the front-rear arrow in the drawings correspond to the horizontal direction, the vertical direction, and the front-rear direction of the vehicle seat 1. A first direction, a second direction, and a third direction in the claims correspond to the horizontal direction of the vehicle seat 1, the vertical direction of the vehicle seat 1, and the front-rear direction of the vehicle seat 1 in the present embodiment, respectively.

### Configuration of Vehicle Seat 1

As illustrated in FIG. 1, a vehicle seat 1 represents seats installed in vehicles such as automobiles. The present embodiment assumes that the vehicle seat 1 is configured to enable one person to be seated. The vehicle seat 1 includes a seat cushion 2 and a seat back 3, which is attached to the seat cushion 2 and can be tilted forward. The seat cushion 2 configures a seated person's seating face. The seat back 3 configures a seated person's backrest. The seat cushion 2 is bolted, for example, to be secured to a vehicle floor panel (unshown) via leg members, for example, configuring a seat frame (unshown).

An actual vehicle seat may include a headrest attached to the upper part (top surface) of the seat back 3 and a reclining mechanism for adjusting angles between the seat back 3 and the seat cushion 2, for example. However, these configurations do not directly concern the present invention and are not illustrated or described.

### Configuration of Seat Cushion 2

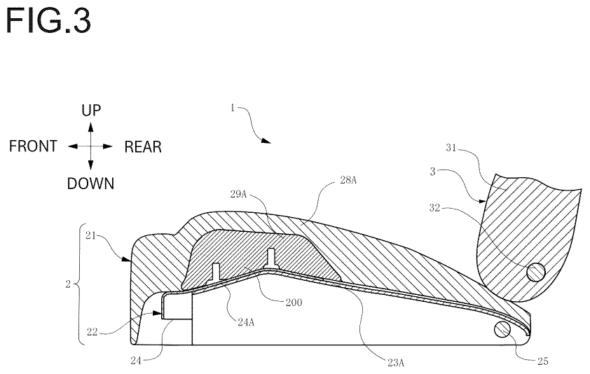

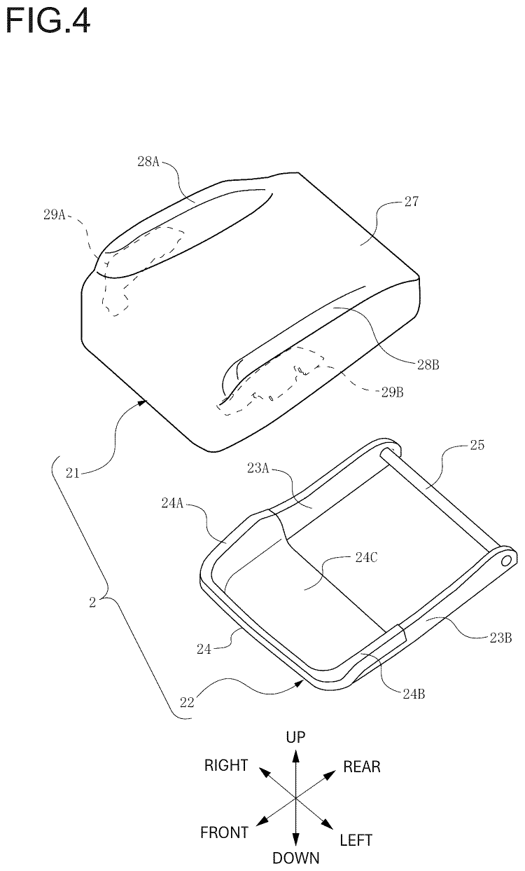

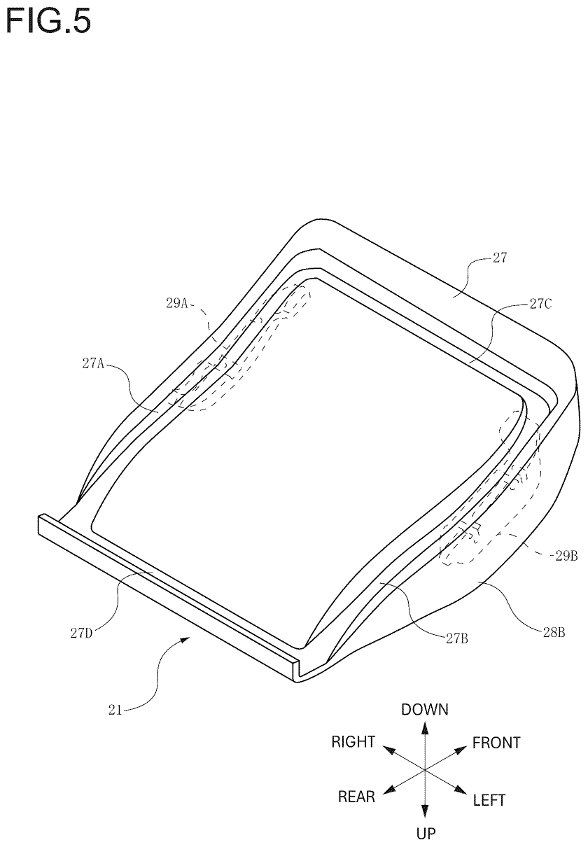

The following describes the configuration of the seat cushion 2 by referencing FIGS. 3 through 5. FIG. 3 is a cross-sectional view taken along the line III-III of FIG. 2. FIG. 4 is an exploded perspective view of the seat cushion 2. FIG. 5 is a bottom perspective view of a seat cushion pad 21.

As illustrated in FIG. 3, the seat cushion 2 includes a seat cushion pad 21 (seat pad) and a seat cushion frame 22. The seat back 3 includes a seat back pad 31 and a seat back frame 32. The seat back frame 32 is coupled to the rear end of the seat cushion frame 22 to be able to be tilted via a pivot mechanism (unshown) and a reclining device.

### Configuration of Seat Cushion Frame 22

As illustrated in FIG. 4, the seat cushion frame 22 includes a pair of right and left side frames 23A and 23B (frame members) , a front frame 24, and a rear frame 25. The side frames 23A and 23B, the front frame 24, and the rear frame 25, which configure the seat cushion frame 22, form a rectangular frame in top view. The seat cushion frame 22 is formed from a metal material, for example.

The side frames 23A and 23B are formed into a plate shape and extend in the front-back direction. The side frames 23A and 23B are members formed by bending a metal plate, for example. The rear frame 25 couples the rear ends of the side frames 23A and 23B. The rear frame 25 is formed into a columnar or cylindrical shape and extends horizontally.

The front frame 24 couples the front ends of the side frames 23A and 23B. More specifically, the front frame 24 includes coated portions 24A and 24B, and a coupling portion 24C. The coated portions 24A and 24B cover the upper surfaces of the front end portions of the side frames 23A and 23B, respectively. The coupling portion 24C is formed into a flat plate to make connections between the coated portions 24A and 24B. The coated portions 24A and 24B, as well as the coupling portion 24C, are integrally formed from a metal plate.

### Configuration of Seat Cushion Pad 21

The seat cushion pad 21 is configured as a molded foam including a main structure portion 27, side support portions 28A and 28B, and insert materials 29A and 29B. The main structure portion 27 configures a seating face that extends in the front-back and horizontal directions and supports a seated person. Concerning the main structure portion 27, the front-back direction corresponds to a longer direction, and the left-right direction corresponds to a shorter direction.

The side support portions 28A and 28B are positioned at both horizontal ends of the main structure portion 27. The main structure portion 27 and the side support portions 28A and 28B are integrally formed by foam molding using a foam material (flexible foam) such as flexible polyurethane foam. The side support portions 28A and 28B protrude vertically from the main structure portion 27 toward a seated person. Consequently, the side support portions 28A and 28B provide sideways support to the seated person.

When the seat cushion pad 21 is viewed sideways (horizontally), the side support portions 28A and 28B are formed into a mound shape so that the center position in the front-back direction is raised and the front and rear end positions are lower than the center. The shape of the side support portions 28A and 28B is not limited thereto. When the seat cushion pad 21 is viewed sideways, for example, the front or rear end position may be lower than the other to form an inclined surface. Moreover, other shapes may be available.

The insert materials 29A and 29B are provided inside the side support portions 28A and 28B and are harder than the side support portions 28A and 28B. The insert materials 29A and 29B are formed to be smaller than the side support portions 28A and 28B in the front-back, vertical, and horizontal directions.

As illustrated in FIG. 5, grooves 27A through 27D are formed on the bottom surface of the main structure portion 27 (seat cushion pad 21). The grooves 27A and 27B extend in the front-to-back direction. The grooves 27C and 27D extend in the horizontal direction. The grooves 27A through 27D form a rectangular frame. The side frames 23A and 23B, the front frame 24, and the rear frame 25 are inserted into grooves 27A through 27D of the seat cushion pad 21. The seat cushion frame 22 supports the peripheral edge of the seat cushion pad 21.

### Configuration of Insert Materials 29A and 29B

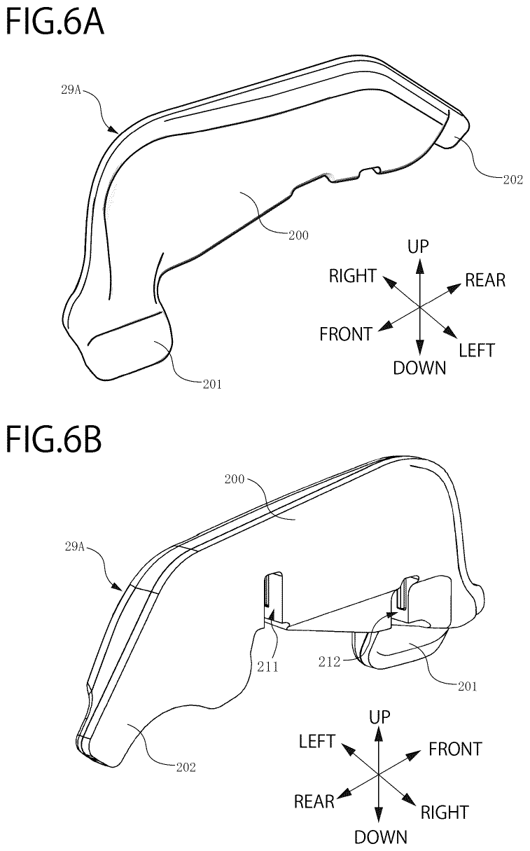

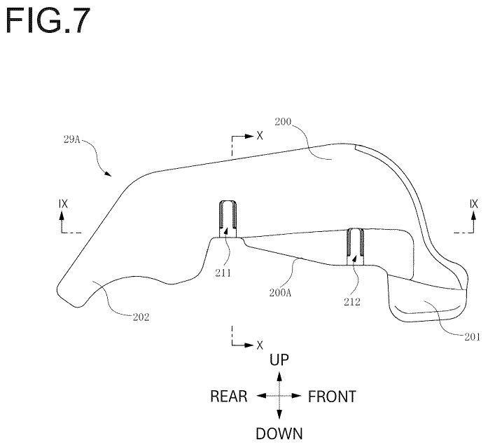

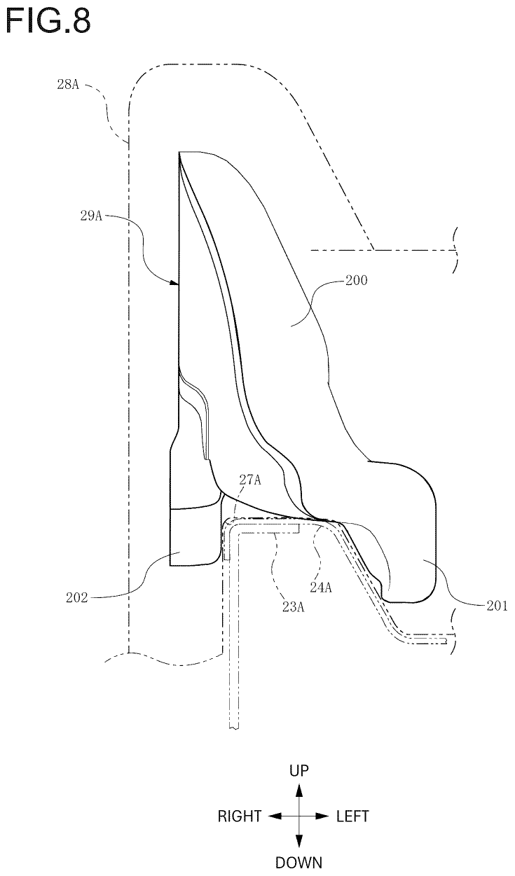

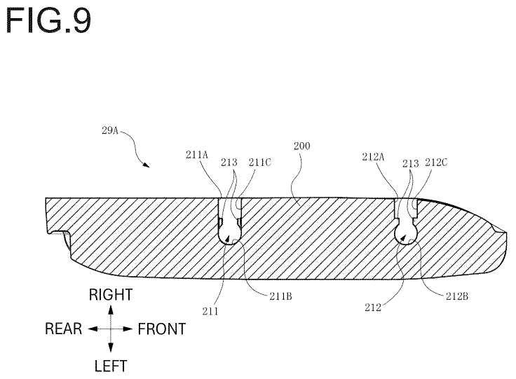

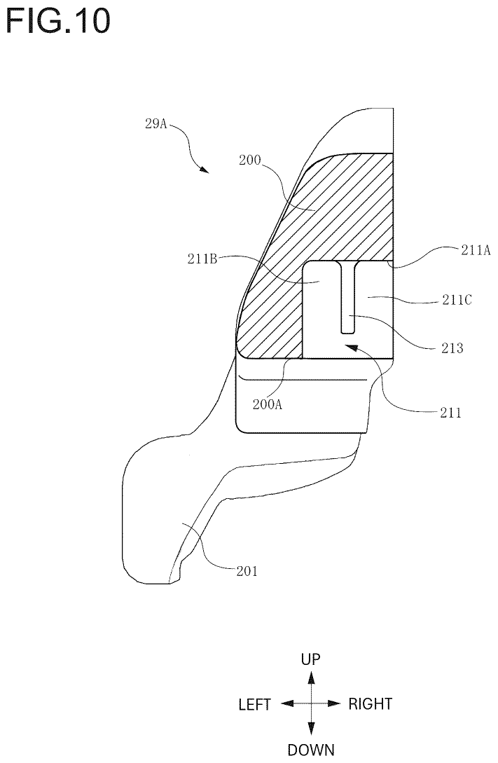

The following describes the detailed configuration of the insert materials 29A and 29B by referencing FIGS. 6 through 10. FIG. 6A is a front perspective view of an insert material 29A, and FIG. 6B is a rear perspective view of the insert material 29A. FIG. 7 is a right side view of the insert material 29A (a side view viewed from the right horizontally). FIG. 8 is a front view of the insert material 29A (a view viewed from the front in the front-back direction). FIG. 9 is a cross-sectional view taken along the line IX-IX of FIG. 7. FIG. 10 is a cross-sectional view taken along the line X-X of FIG. 7. The insert materials 29A and 29B are configured similarly. The following description will mainly focus on the insert material 29A. A description of the insert material 29B will be omitted.

As illustrated in FIGS. 6A and 6B, the insert material 29A includes an insert material main structure portion 200, a first leg portion 201, and a second leg portion 202. The insert materials 29A and 29B are harder than the side support portions 28A and 28B. More specifically, the insert material main structure portion 200, the first leg portion 201, and the second leg portion 202 of the insert materials 29A and 29B are integrally molded from a foam material (expanded polypropylene according to the present embodiment). The side frame 23A supports the insert material main structure portion 200 via the coated portion 24A of the front frame 24 (see FIG. 3). The side frame 23B supports the insert material main structure portion 200 of the insert material 29B via the coated portion 24B of the front frame 24.

As illustrated in FIG. 7, the insert material main structure portion 200 is shaped similarly to the side support portions 28A and 28B and is formed to be smaller than the side support portions 28A and 28B in the front-back, horizontal, and vertical directions.

### Configuration of First Leg Portion 201 and Second Leg Portion 202

The first leg portion 201 and the second leg portion 202 are placed at both horizontal ends of the insert material main structure portion 200. The first leg portion 201 and the second leg portion 202 are positioned at both horizontal sides of the groove 27A in the main structure portion 27 (seat cushion pad 21). More specifically, as illustrated in FIGS. 7 and 8, the first leg portion 201 is positioned at the left end in the horizontal direction (to the left of the groove 27A) and at the front end in the front-back direction of the insert material main structure portion 200, and extends vertically. The second leg portion 202 is positioned at the right end in the horizontal direction (to the right of the groove 27A) and at the rear end in the front-back direction of the insert material main structure portion 200, and extends vertically. In other words, when the side frame 23A supports the insert material main structure portion 200, the first leg portion 201 is positioned at the left side of the side frame 23A, and the second leg portion 202 is positioned at the right side of the side frame 23A. Therefore, the first leg portion 201 and the second leg portion 202 are positioned to sandwich the side frame 23A, making it possible to position the seat cushion pad 21 to the side frame 23A horizontally.

When the side frame 23B supports the insert material main structure portion 200 of the insert material 29B, the first leg portion 201 is positioned at the right side of the side frame 23B, and the second leg portion 202 is positioned at the left side of the side frame 23A. Therefore, the first leg portion 201 and the second leg portion 202 of the insert material 29B position the seat cushion pad 21 to the side frame 23B horizontally.

### Configuration of Pin Holes 211 and 212

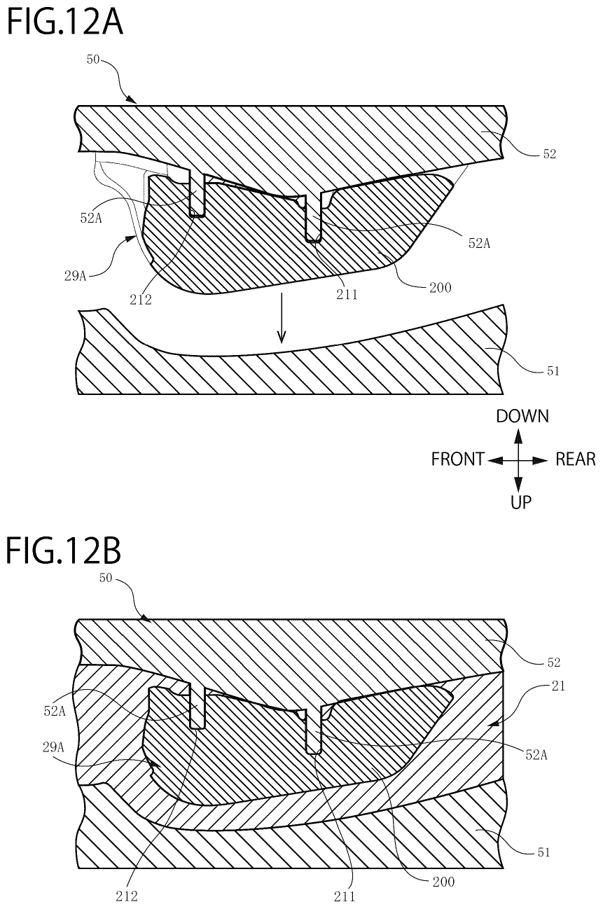

As illustrated in FIG. 7 and FIG. 9, the insert material main structure portion 200, and pin holes 211 and 212. The pin holes 211 and 212 are aligned in the front-back direction. The pin holes 211 and 212 extend vertically from the bottom surface 200A (bottom end surface in the vertical direction) of the insert material main structure portion 200 and include open portions 211A and 212A, respectively, opened at one end (the right side in the present embodiment) in the horizontal direction. The pin holes 211 and 212 can vertically engage with positioning pins 52A (see FIGS. 12A and 12B) used to foam-mold the seat cushion pad 21. The pin holes 211 and 212 are equally shaped internally.

The pin holes 211 and 212 respectively include semicircular portions 211B and 212B whose inner diameter corresponds to the outer diameter of the positioning pin 52A, and respectively include straight portions 211C and 212C that communicate with the semicircular portions 211B and 212B and the opened portions 211A and 212A and are dimensioned in the front-back direction to correspond to the outer diameter of the positioning pin 52A.

The insert material 29A includes a pair of protruded portions 213 formed inside the pin holes 211 and 212. The protruded portion 213 protrudes in the front-back direction from each of the faces of the straight portions 211C and 212C. The protruded portion 213 extends vertically. When the positioning pins 52A engage with the pin holes 211 and 212, the protruded portion 213 prevents the positioning pin 52A from disengaging horizontally.

### Manufacturing Process of Insert Material 29A

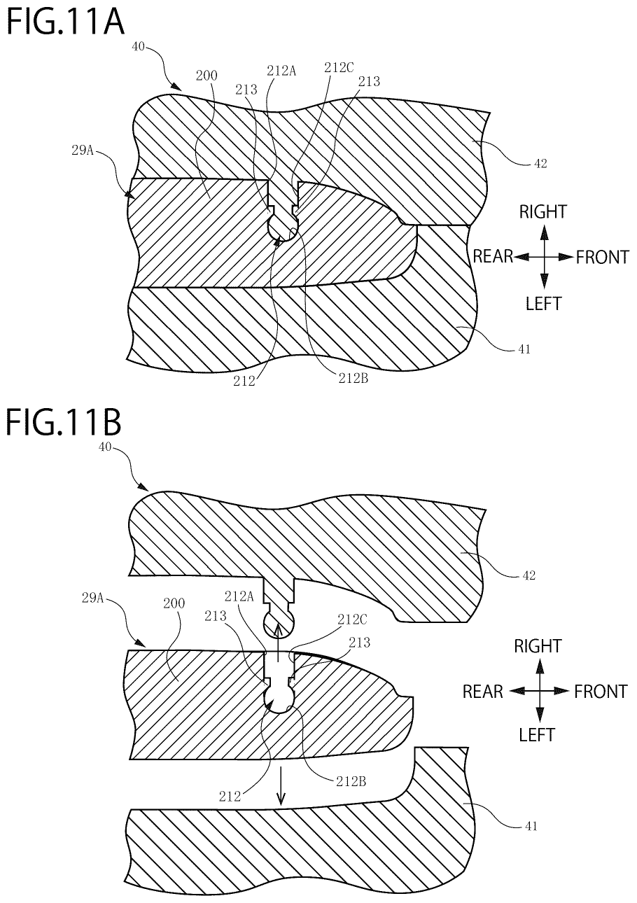

The following describes the manufacturing process of the insert material 29A by referencing FIGS. 11A and 11B. The manufacturing process of the insert material 29B is similar to that of the insert material 29A, and will not be described. The horizontal, vertical, and front-back directions illustrated in FIGS. 11A, 11B,12A and 12B correspond to the horizontal, vertical, and front-back directions of the vehicle seat 1.

As illustrated in FIG. 11A, a mold 40 molds the insert material 29A. The mold 40 includes a cavity 41 and a core 42, both of which open and close horizontally. The manufacturing process for the insert material 29A uses the mold 40. Foam material is injected into the closed mold 40 to form the insert material 29A.

As illustrated in FIG. 11B, the pin holes 211 and 212 include the open portions 211A and 212A at one end in the horizontal direction, allowing the cavity 41 and the core 42 to open and close horizontally. In other words, the core 42 (mold 40) to mold the insert material 29A can be released horizontally. The protruded portion 213 is placed inside the pin holes 211 and 212. The core 42, when moved in the opening direction, hits the protruded portion 213. The insert material 29A, molded from an elastic foam material, does not prevent the core 42 from moving (allowing it to be released horizontally), causing no undercut. The insert materials 29A and 29B, fabricated as above, are used to foam-mold the seat cushion pad 21.

### Foam Molding of Seat Cushion Pad 21

The following describes foam molding as a manufacturing process of the seat cushion pad 21 by referencing FIGS. 12A and 12B. The manufacturing process of the seat cushion pad 21 uses a mold 50 composed of a cavity 51 and a core 52, both of which open and close vertically.

During the foam molding, as illustrated in FIG. 12A, the insert materials 29A and 29B are positioned to the core 52 in the opened mold 50, and an undiluted solution of the soft foam material is injected into the cavity 51. During the foam molding, the insert materials 29A and 29B are positioned to the side support portions 28A and 28B by vertically engaging the positioning pin 52A with the pin holes 211 and 212 of the insert materials 29A and 29B. The positioning pin 52A is configured integrally with the core 52. The positioning pin 52A is formed to be approximately columnar and extends vertically.

As illustrated in FIG. 12B, the core 52 is moved to close the opened mold 50. The foam material is foamed and hardened inside the mold 50 to foam-mold the seat cushion pad 21 embedded with the insert materials 29A and 29B inside. Then, the mold 50 opens. The foam-molded seat cushion pad 21 is removed from the mold 50.

The following describes the effects of the present embodiment configured as above.

According to the present embodiment, the insert materials 29A and 29B, which are harder than the side support portions 28A and 28B, are provided inside the side support portions 28A and 28B of the seat cushion pad 21 made of molded foam. When the seat cushion pad 21 is foam-molded, the insert materials 29A and 29B can vertically engage with the positioning pin 52A for positioning to the side support portions 28A and 28B, and include the pin holes 211 and 212 that are open at one horizontal end. The insert materials 29A and 29B can be molded thinly horizontally. According to a conventional configuration, the insert material includes a positioning hole to engage with the positioning pin 52A and needs to be thickened in the horizontal direction perpendicular to the positioning hole. According to the present embodiment, the positioning pin 52A engages with the pin holes 211 and 212, whose one end is open. There is no need to thicken the horizontal one end of the pin holes 211 and 212. The insert materials 29A and 29B can be molded thinly. It is possible to enlarge the seating face for the seat cushion pad 21, improving degrees of freedom in the design of the seat cushion pad 21.

The pin holes 211 and 212 include the semicircular portions 211B and 212B whose inner diameter conforms to the outer diameter of the positioning pin 52A, and the straight portions 211C and 212C that communicate with the semicircular portions 211B and 212B and the opened portions 211A and 212A and are dimensioned in the front-back direction to conform to the outer diameter of the positioning pin 52A. It is possible to release the mold 40, which molds the insert materials 29A and 29, reliably horizontally and further improve degrees of freedom in the design of the seat cushion pad 21.

The protruded portion 213 is formed inside the pin holes 211 and 212 and protrudes in the front-to-back direction. When the positioning pin 52A engages with the pin holes 211 and 212, the protruded portion 213 prevents the positioning pin 52A from disengaging horizontally. The insert material 29A and 29B can be precisely positioned inside the side support portions 28A and 28B to foam-mold the seat cushion pad 21.

The insert materials 29A and 29B include the first leg portion 201 and the second leg portion 202, respectively, positioned on both horizontal sides of the side frames 23A and 23B. The first leg portion 201 and the second leg portion 202 are placed to sandwich the side frame 23A. The seat cushion pad 21 can be horizontally positioned to the side frames 23A and 23B. The insert materials 29A and 29B can be accurately positioned to the side frames 23A and 23B horizontally, thereby improving the support efficiency of the seat cushion pad 21.

The present invention is not limited to the above-described embodiment. Various modifications are possible without departing from the spirit of the present invention. The present invention covers all technical matters encompassed in the technical concept described in the claims. The above-described embodiment represents the preferred examples. Those skilled in the art will be able to embody various alternatives, modifications, variations, combinations, and improvements based on the contents disclosed in the present specification. These are covered by the technical scope described in the appended claims.

For example, according to the above-described embodiment, the seat cushion pad 21 is represented as a seat pad made of molded foam, but is not limited thereto. The seat back pad 31 may be represented as a seat pad made of molded foam. In this case, the seat back pad 31 includes a main structure portion configuring the backrest, a side support portion, and an insert material. The main structure portion extends in the vertical direction and the horizontal direction (first direction). The side support portions are positioned at both ends of the main structure portion in the horizontal direction (first direction), are foam-molded integrally with the main structure portion, and protrude in the front-back direction (second direction). In this case, similar to the above-described embodiment, the insert material is harder than the side support portion, is capable of allowing the seat back pad 31 to engage with the positioning pin in the front-back direction (second direction) during foam molding, and includes a pin hole whose one end is opened in the horizontal direction (first direction). It is possible to achieve the same effect as the above-described embodiment. In this case, the seat back frame 32 includes a pair of side frames (frame members), similar to the seat cushion frame 22. The insert material is positioned on the side frames of the seat back frame 32 in the first direction.

According to the above-described embodiment, the first, second, and third directions are configured orthogonal to each other, but are not limited thereto.

The first, second, and third directions merely need to intersect correspondingly.

What is claimed is:

1. A molded foam configuring a seat pad for a vehicle Seat, comprising:
a main structure portion that extends in a longer direction and a shorter direction and configures a seating face or a backrest;
a side support portion that is placed at both ends of the main structure portion in a first direction as the shorter direction, is molded integrally with the main structure portion, and protrudes in a second direction intersecting the first direction; and
an insert material provided that is provided inside the side support portion and is harder than the side Support portion,
wherein the insert material includes a pin hole capable of engaging with a positioning pin that is used for positioning to the side support portion during foam molding and extends in the second direction; and
wherein the pin hole includes an opened portion opened at one end in the first direction to release a mold for molding the insert material in the first direction.

2. The molded foam according to claim 1,
wherein the pin hole includes a semicircular portion whose inner diameter conforms to an outer diameter of the positioning pin, and a straight portion that communicates with the semicircular portion and the opened portion and is dimensioned, in a third direction intersecting the first and second directions to conform, to the outer diameter of the positioning pin.

3. The molded foam according to claim 2,
wherein the insert material includes a protruded portion formed to be placed inside the pin hole and protrude in the third direction; and
wherein, when the positioning pin engages with the pin hole, the protruded portion prevents the positioning pin from disengaging in the first direction.

4. A vehicle seat comprising the molded foam according to claim 1 and a frame that supports the molded foam,
wherein the frame includes a frame member that extends in a third direction intersecting the first and second directions;
wherein the insert material includes an insert material main structure portion supported by the frame member, and a first leg portion and a second leg portion, which are placed on both sides of the frame member in the first direction and are integrally formed with the insert material main structure portion; and
wherein the first leg portion and the second leg portion position the molded foam to the frame member in the first direction.
